(19) United States
(12) Patent Application Publication
(10) Pub. No.: US 2007/0107526 A1
(43) Pub. Date: May 17, 2007

(54) Load sensor

(75) Inventors: Yoshiharu Terauchi, Miyagi-ken (JP); Ryoichi Maeda, Miyagi-ken (JP)

Correspondence Address: BEYER WEAVER LLP, P.O. BOX 70250, OAKLAND, CA, 94612-0250, US

(73) Assignee: ALPS ELECTRIC CO., LTD.

(21) Appl. No.: 11/586,240

(22) Filed: Oct. 24, 2006

(30) Foreign Application Priority Data
Nov. 15, 2005 (JP) 2005-329955

(51) Int. Cl. G01B 5/30; G01B 7/16

(52) U.S. Cl. 73/760

(57) ABSTRACT

A load sensor includes fixed portions, a load bearing portion subjected to a load, and strain detecting elements each detecting a strain of a substrate in response to the load. In this load sensor, slits each of which can disperse a stress applied to the substrate in response to the load, are formed in the substrate.

### BACKGROUND OF THE INVENTION

1. Field of the Invention

The present invention relates to a load sensor, and specifically to a load sensor suitable for detection of a load upon a seat of an automobile or the like.

2. Description of the Related Art

Conventionally, the load sensor is used to various applications, such as the detection of a load upon a seat of an automobile, the detection of a force applied to a pointing device, and the like. For example, Japanese Unexamined Patent Application Publication No. 7-174646 discloses a load sensor wherein a load bearing portion serving as an operation portion is arranged in a substantially central portion on an elastic substrate and fixed portions are provided at end portions of the substrate, and wherein a strain detecting element is arranged between the load bearing portion and each of the fixed portions. Such a load sensor is configured to detect strains of the substrate in response to a load upon the load bearing portion by the strain detecting elements, and thereby to detect the magnitude and direction of the load upon the load bearing portion.

However, in the conventional load sensor as described above, undesirably, a stress applied to the substrate in response to a load is concentrated on positions on the substrate in the neighborhood of the load bearing portion and fixed portions. This causes a problem in that strains of the substrate in response to a load cannot be properly detected by the detecting elements.

### SUMMARY OF THE INVENTION

Accordingly, it is an object of the present invention to provide a load sensor capable of dispersing the stress applied to the substrate in response to a load, and thereby properly detecting the magnitude and direction of the load.

A load sensor according to the present invention includes fixed portions, a load bearing portion subjected to a load, and strain detecting elements each detecting a strain of a substrate in response to the load, wherein slits each of which can disperse a stress applied to the substrate in response to the load, are formed in the substrate.

With this arrangement, since the stress applied to the substrate in response to the load is dispersed by the slits formed in the substrate, it is possible to avoid stress concentration on definite positions on the substrate, and to detect strains of the substrate in response to the appropriately dispersed stress by strain detecting elements. This allows the magnitude and direction of the load to be properly detected.

In the above-described load sensor, it is preferable that the strain detecting elements be disposed between each of the fixed portions and the load bearing portion. Thus disposing the strain detecting elements between each of the fixed portions and the load bearing portion, which are most susceptible to stress upon the substrate, allows the magnitude and direction of the load to be detected with even higher accuracy.

In the above-described load sensor, for example, the slits may be each formed in the neighborhood of the strain detecting elements. In this case, since the stress applied to the substrate in the neighborhood of the strain detecting elements is dispersed, directly detecting stresses dispersed by the strain detecting element enables the magnitude and direction of the load to be detected with even higher accuracy.

In particular, it is preferable that a pair of the slits be formed so as to sandwich the strain detecting elements. In this case, since the stress applied to the substrate is dispersed by the pair of slits sandwiching the strain detecting elements, the stress applied to the substrate can be uniformly dispersed.

In the above-described load sensor, it is preferable that the ends of the slit be each formed into a round shape. In this case, since the stress applied to the substrate can be borne by the round shape portions of the slits, it is possible to avoid stress concentration on the ends of the slits, and to prevent the occurrence of a failure of the substrate and a reduction of the product life that can be caused by the above-described stress concentration on the ends of the slits.

In the above-described load sensor, the slit may be formed into a substantially heart shape. In this case also, since the stress applied to the substrate can be borne by the round shape portions included in the substantially heart shape, it is possible to avoid stress concentration on the ends of the slits, and to prevent the occurrence of a failure of the substrate and a reduction of the product life that can be caused by the above-described stress concentration on the ends of the slits.

A load sensor according to the present invention includes fixed portions, a load bearing portion subjected to a load, and strain detecting elements each detecting a strain of a substrate in response to the load, wherein opening portions each of which can disperse a stress applied to the substrate in response to the load, are formed in the substrate.

With this arrangement, since the stress applied to the substrate in response to the load is dispersed by the opening portions formed in the substrate, it is possible to avoid stress concentration on definite positions and to detect strains of the substrate in response to the appropriately dispersed stress by strain detecting elements. This allows the magnitude and direction of the load to be properly detected.

It is preferable that the strain detecting elements be disposed between each of the fixed portions and the load bearing portion. Thus disposing the strain detecting elements between each of the fixed portions and the load bearing portion, which are most susceptible to stress upon the substrate, allows the magnitude and direction of the load to be detected with even higher accuracy.

In the above-described load sensor, for example, the opening portions may be each formed in the neighborhood of the strain detecting elements. In this case, since the stress applied to the substrate in the neighborhood of the strain detecting elements is dispersed, directly detecting the dispersed stress by the strain detecting element allows the magnitude and direction of the load to be detected with even higher accuracy.

In particular, it is preferable that a pair of opening portions be formed so as to sandwich the strain detecting elements. In this case, since the stress is dispersed by the pair of slits sandwiching the strain detecting elements, the stress applied to the substrate can be uniformly dispersed.

In the above-described load sensor, the opening portions may be formed into a substantially heart shape. In this case also, since the stress applied to the substrate can be borne by the round shape portions included in the substantially heart shape, it is possible to avoid stress concentration on the ends of the opening portions, and to prevent the occurrence of a failure of the substrate and a reduction of the product life caused by the above-described stress concentration on the ends of the opening portions.

In the above-described load sensor, the arrangement may be such that the fixed portions are each disposed at a corner portion of a substantially square substrate, and that the load bearing portion is disposed in a central portion of this substrate. In this case, since the main body of the sensor can be fixed on a mounting base at four fixed portions, it is possible to provide a load sensor that is resistant to torsion applied to the substrate in response to a load.

According to the present invention, it is possible to disperse stress applied to the substrate in response to a load to thereby properly detect the magnitude and direction of the load.

### BRIEF DESCRIPTION OF THE DRAWINGS

FIG. 1 is a perspective view showing the construction of a substrate of a load sensor according to an embodiment of the present invention;

FIG. 2 is a plan view showing wiring patterns formed on the substrate in FIG. 1;

FIG. 3 is a plan view showing a distribution of stress applied to the substrate of the load sensor according to the embodiment;

FIG. 4 is a graph showing stresses in accordance with positions from the end of a load bearing portion to a fixed portion in the substrate in FIG. 3;

FIG. 5 is a plan view showing a stress distribution in a load sensor having a substrate without any slit;

FIG. 6 is a graph showing stresses in accordance with positions from the end of a load bearing portion to a fixed portion in the substrate in FIG. 5;

FIG. 7 is a plan view showing a stress distribution in a load sensor having a substrate without any round-shape portion at the ends of slits; and

FIG. 8 is a plan view showing a stress distribution in a load sensor having a substrate with a notch in the center of each of its sides.

### DESCRIPTION OF THE PREFERRED EMBODIMENTS

Hereinafter, an embodiment of the present invention will be described with reference to the accompanying drawings.

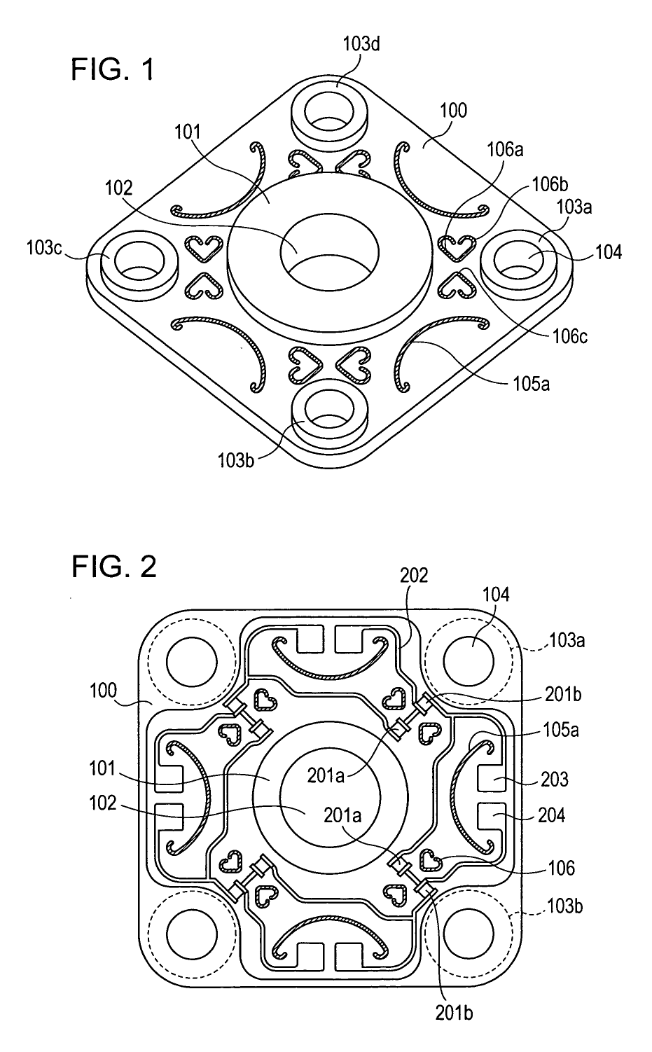

First, the construction of a load sensor according to the embodiment of the present invention is described using FIGS. 1 and 2. FIG. 1 is a perspective view showing the construction of a substrate of the load sensor according to the embodiment of the present invention. FIG. 2 is a plan view showing wiring patterns formed on the substrate in FIG. 1.

The load sensor according to this embodiment has a substrate 100 made of a metal plate such as a stainless plate. As shown in FIG. 1, the substrate 100 is a flexible flat plate with a fixed thickness and formed into a substantially square shape. In a central portion of the substrate 100, there is provided a load bearing portion 101 subjected to a load. The load bearing portion 101 protrudes from the substrate 100 in an arcuate shape in section, and has a hole 102 inside it. At corners of the substrate 100, there are provided four fixed portions 103 for mounting this load sensor on the mounting base (not shown). As in the case of the load bearing portion 101, each of the fixed portions 103 also protrudes from the substrate 100 in an arcuate shape in section, and has a mounting hole 104 inside it. Here, the height of the fixed portion 103 is arranged to be lower than that of the load bearing portion 101. However, the height of the load bearing portion 101 may be either equal to or higher than that of the fixed portion 103. Hereinafter, fixed portions 103 on the right side, lower side, left side, and upper side are referred to as fixed portions 103a, 103b, 103c, and 103d, respectively.

When such a substrate 100 is installed on a seat of an automobile or the like, mounting screws (not shown) are inserted through the mounting holes 104 of the fixed portions 103 and fastened to an automobile body, as well as a lever (not shown) abutted against a portion of the seat is engaged with the hole 102 of the load bearing portion 101. The substrate 100 is bent as appropriate by a load applied to the above-described lever, and consequently strain stresses are applied to strain detecting elements that will be described later, whereby the load is detected.

Slits 105 each having a substantially C-shape that opens toward the outside of the substrate, i.e., in the direction of a side of the substrate, are each formed between the fixed portions 103. For example, between the fixed portion 103a and fixed portion 103b, there is provided a slit 105a, which has a shape that opens in the direction of the side between the fixed portions 103a and 103b. Here, the ends of the slit 105 each have a round shape directed toward the inside of the slit 105.

In the load sensor according to this embodiment, by forming such slits 105 at predetermined positions on the substrate, it is possible to disperse the stress applied to the substrate 100 while maintaining spaces for forming wiring patterns on the substrate 100. In particular, forming slits with substantially C-shape each opening toward the outside of the substrate 100, between the fixed portions 103, ensures the flexibility of the substrate 100 as in the case where the substrate would be formed into a cruciform.

Between the load bearing portion 101 and each of the fixed portions 103, there are provided a pair of slits 106 having the same shape. Each pair of slits 106 have symmetrical shapes with respect to a line connecting the center of the load bearing portion 101 and the center of a respective one of the fixed portions 103. Each pair of slits 106 that are mutually opposed are spaced apart by a predetermined distance. The pair of slits 106 has each rectilinear portions 106a that substantially orthogonally intersect each other, and round shape portions 106b each being directed from the ends of the rectilinear portions 106a toward the inside of the slit, thereby forming a substantially heart shape. The pair of slits 106 are configured so that the ends 106c in the slits 106a that substantially orthogonally intersect each other (hereinafter, these ends are referred to as “orthogonal ends” as appropriate) are opposed to each other.

In the load sensor according to this embodiment, by forming such pairs of slits at predetermined positions on the substrate, it is possible to disperse the stress applied to the substrate 100 in response to a load upon the load bearing portion 101.

As shown in FIG. 2, between the load bearing portion 101 and each of fixed portion 103, and in the neighborhood of the pair of slits 106, there are provided a pair of strain detecting elements 201 (201a and 201b). Specifically, the pair of strain detecting elements 201 are provided on the line connecting the center of the load bearing portion 101 and the center of each the fixed portions 103. Also, with respect to a line connecting the orthogonal ends 106c of the slit 106, the strain detecting element 201a as one of the pair of strain detecting elements 201 is disposed on the side of the load bearing portion 101, and the strain detecting element 201b as the other of the pair of strain detecting elements 201 is disposed on the side of the fixed portion 103.

As shown in FIG. 2, the strain detecting elements 201 are provided in twos between the load bearing portion 101 and each of the fixed portions 103, and in total, eight strain detecting elements 201 are arranged on the substrate 100. The strain detecting elements 201 detect strains of the substrate 100 in response to a load upon the load bearing portion 101. The strain detecting element is made of, for example, a material formed by dispersing a metal or metal oxide constituted of an electrically conductive material into a binder constituted of a low-melting glass material or the like. The strain detecting element is arranged so that the electrically conductive material that is dispersed in the binder varies in density under a stress such as a compressive stress or tensile stress to thereby vary in resistance value. Here, the resistance values of all strain detecting elements 201 are set to an identical value.

Each of the strain detecting elements 201a and a respective one of the strain detecting elements 201b are connected via wiring 202, and to these, an input electrode 203, output electrode 204, and ground electrode (not shown) are connected via the wiring 202, thereby forming a bridge circuit. Each of the input electrodes 203 and a respective one of the output electrodes 204 are disposed in a region formed between a corresponding slit 105 and a corresponding side portion facing the opening portion side of the pertinent slit 105 (hereinafter, this region is referred to as a “slit external region”). Here, the strain detecting elements 201 and wiring patterns with respect thereto are formed on the substrate 100 by, for example, printing them at desired positions with an electrically conductive ink. However, this method for forming the strain detecting elements 201 and wiring patterns is not restrictive.

The input electrode 203 is connected to the end of a strain detecting element 201a provided in the neighborhood of the pertinent side portion which end is adjacent to the load bearing portion 101, and the end of a strain detecting element 201b, adjacent to the fixed portion 103a across the pertinent side portion, via the wiring 202. On the other hand, the output electrode 204 is connected to the end of the strain detecting element 201b provided in the neighborhood of the pertinent side portion via the wiring 202, the end being adjacent to the load bearing portion 101. Specifically, the input electrode 203 provided in the slit external region of the slit 105a is connected to the end of the strain detecting element 201b provided in the neighborhood of the fixed portion 103a, the end being adjacent to the 103a; while it is connected to the end of the strain detecting element 201a provided in the neighborhood of the fixed portion 103b, the end being adjacent to the load bearing portion 101. On the other hand, the input electrode 204 provided in the slit external region of the slit 105a is connected to the end of the strain detecting element 201b provided in the neighborhood of the fixed portion 103b, the end being adjacent to the 103a.

In a state where no load is applied to the strain detecting elements 201, the bridge circuit is in balance. If a load is applied to the load bearing portion 101, the substrate 100 bends, and the strain detecting elements 201a and 210b distort in proportion to the load so as to be compressed or expanded, so that resistance values of the strain detecting elements 201 change. A voltage applied to the bridge circuit by the input electrode 203 is divided by the strain detecting elements 201, and appears as a differential voltage of the output electrode 204. This differential voltage is converted into, e.g., a weight value by a circuit (not shown).

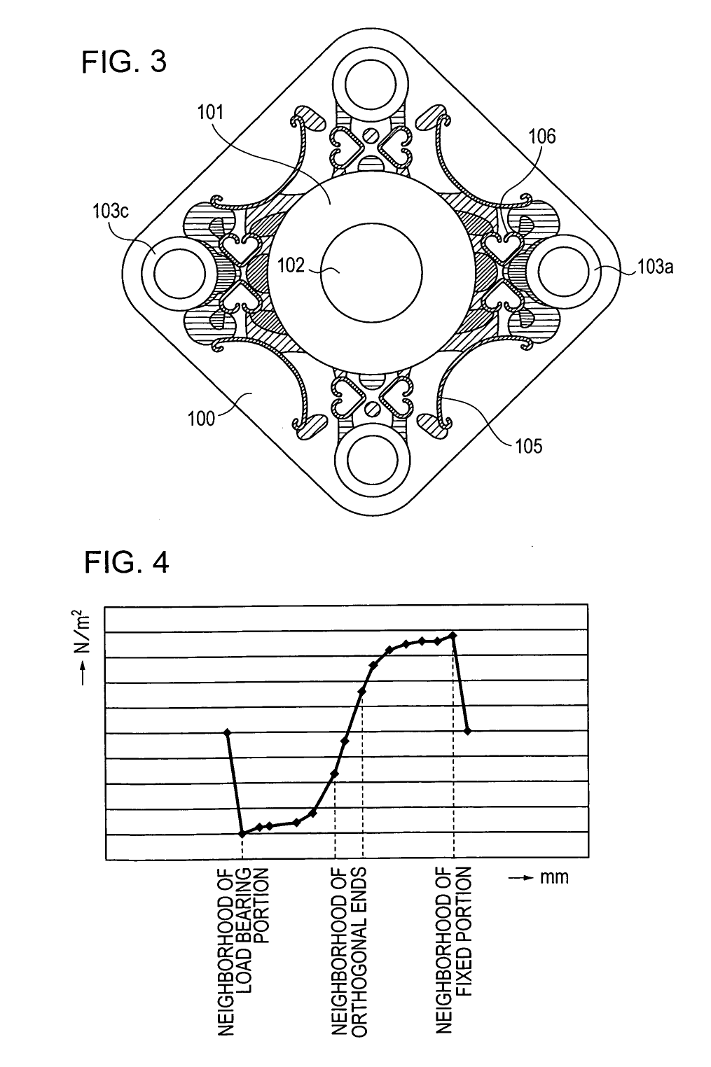

Next, the distribution of stress applied to the substrate 100 of the load sensor according to this embodiment will be described with reference to FIGS. 3 and 4. FIG. 3 is a plan view showing a distribution of stress applied to the substrate 100. FIG. 4 is a graph showing stresses in accordance with positions from the end of the load bearing portion 101 to the fixed portion 103a in the substrate 100 in FIG. 3. In FIG. 3, the compressive stress serving as a stress applied to the substrate 100 is indicated by oblique lines, and the tensile stress serving as a stress applied to the substrate 100 is indicated by horizontal lines. Here, the spacings between solid lines in the oblique lines and horizontal lines are made smaller as the magnitude of the compressive or tensile stresses increases. In other words, the larger the compressive or tensile stress, the smaller are the spacings between solid lines. For convenience of description, in FIG. 3, the compressive and tensile stresses are each classified into two levels.

In this load sensor, when a load is applied to the load bearing portion 101, as shown in FIG. 3, a stress is mainly applied to the substrate 100 along the direction of a straight line connecting the centers of the fixed portion 103a, load bearing portion 101, and fixed portion 103c. Specifically, a compressive stress is applied to the portions from the slits 106 up to the fixed portions 103 while a tensile stress is applied to the portions from the slits 106 up to the fixed portions 103.

More specifically, the compressive stress is applied to the portions from the neighborhood of the peripheral surface of the load bearing portion 101 up to the neighborhood of the orthogonal ends 106c along one of the straight line portions 106a of the slit 106, while the tensile stress is applied to the portion from the neighborhood of the peripheral surface of the fixed portion 103a up to the neighborhood of the orthogonal ends 106c along the other of the straight line portions 106a of the slit 106.

In this case, as shown in FIG. 4, the stress continues to maintain a high compressive stress on the portion from the load bearing portion 101 up to the neighborhood of the orthogonal ends 106c. The stress changes from the compressive stress into the tensile stress with the orthogonal ends 106c of the slit 106 as a boundary, and it continues to maintain a high tensile stress on the portion from the neighborhood of the orthogonal ends 106c up to the fixed portion 103a. For example, at the nearest position to the load bearing portion 101, a compressive stress of −3e+8 [N/m²] to −5e+8 [N/m²] is applied, and up to the neighborhood of the orthogonal ends 106c, the same level of the compressive stress is applied although it slightly decreases. On the other hand, at the nearest position to the fixed portion 103, a tensile stress of +3e+8 [N/m²] to +5e+8 [N/m²] is applied, and up to the neighborhood of the orthogonal ends 106c, the same level of the tensile stress is applied although it slightly decreases.

In the load sensor according to this embodiment, since the slits 106 are provided in the neighborhood of the strain detecting elements 201 so as to disperse stresses (compressive stress and tensile stress) applied to the substrate 100, it is possible to avoid the concentration of stresses applied to the substrate 100 on definite positions on the substrate 100, and to properly detect strains of the substrate 100 by strain detecting elements 201.

When a load is applied to the load bearing portion 101, as shown in FIG. 3, a compressive stress is applied to the portion from the peripheral surface of the load bearing portion 101 up to the neighborhood of one of the round shape portions 106b of the slit 106, while a tensile stress is applied to the portion from the peripheral surface of the fixed portion 103a up to the neighborhood of the other of the round shape portion 106b of the slit 106. At this time, in the neighborhood of the round shape portions 106b of the slit 106, stresses (compressive stress and tensile stress) are applied along the shape of the pertinent round shape portion 106b.

In the load sensor according to this embodiment, since it is arranged that the ends of the slits 106 is each formed into a round shape and that the stress applied to the substrate 100 is borne by the pertinent round shape portions, it is possible to avoid stress concentration on the ends of the slits 106, and to prevent the occurrence of a failure of the substrate and a reduction of the product life caused by the above-described stress concentration on the ends of the slits 106.

When a load is further applied to the load bearing portion 101, as shown in FIG. 3, a stress that twists the substrate 100 is applied to the substrate 100 along the direction of a straight line connecting the centers of the fixed portion 103b, load bearing portion 101, and fixed portion 103d. However, since this load sensor is fixed by the four fixed portions 103a to 103d, an adverse effect of the pertinent stress on the detection of load is reduced.

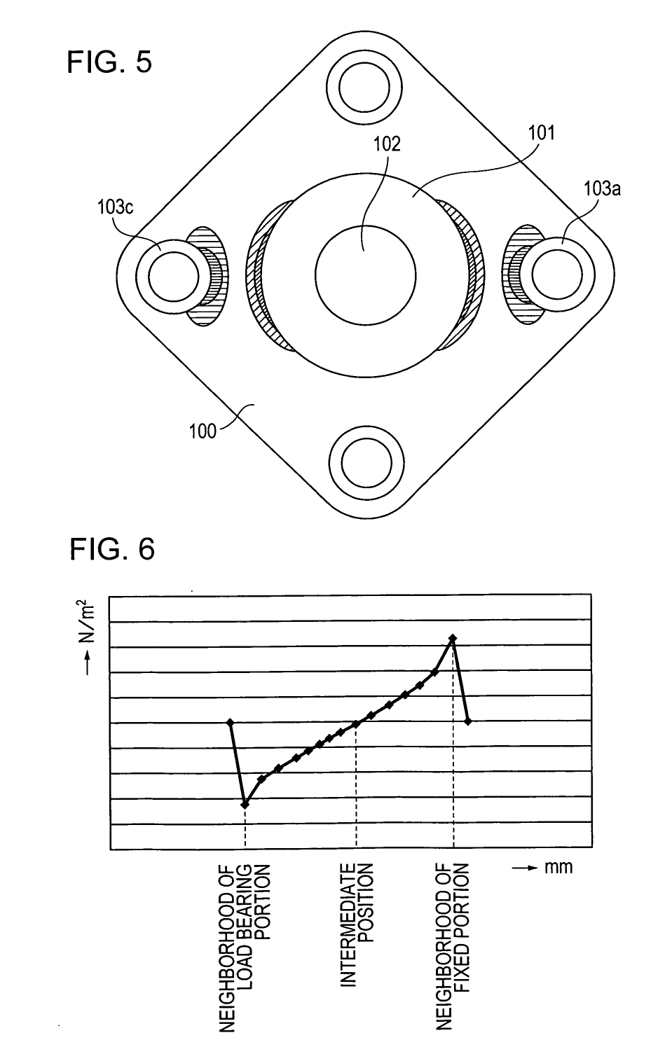

Here, regarding a load sensor adopting a substrate 100 different from that of the present embodiment, distributions of stresses applied to the substrate 100 will be described with reference to FIGS. 5 to 8.

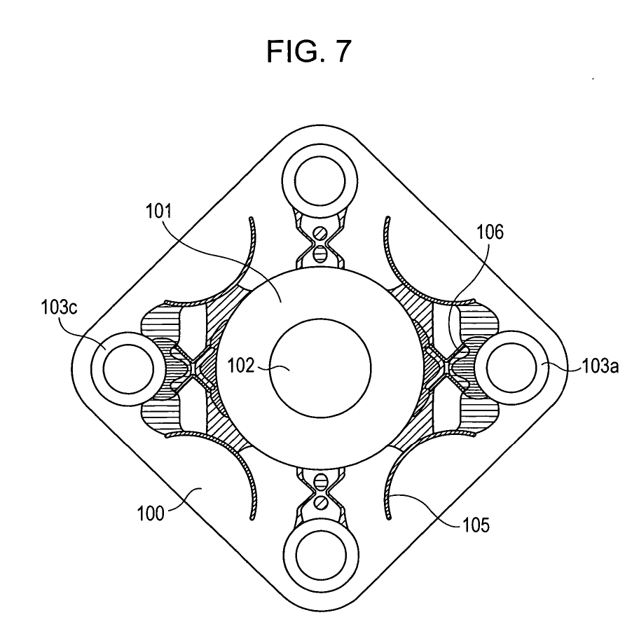

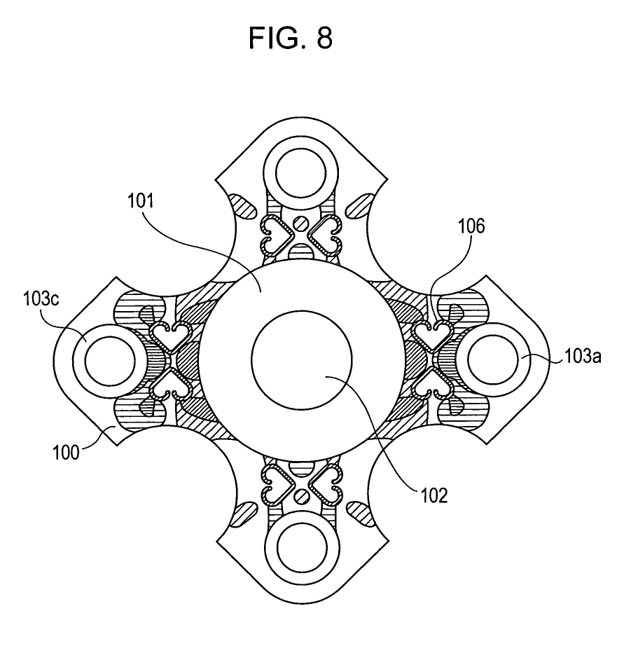

FIG. 5 is a plan view showing a stress distribution in a substrate 100 without any slit. FIG. 6 is a graph showing stresses in accordance with positions from the end of a load bearing portion 101 up to a fixed portion 103a in the substrate 100 in FIG. 5. FIG. 7 is a plan view showing a stress distribution in the substrate 100 without any round-shape portion at the ends of the slits. FIG. 8 is a plan view showing a stress distribution in a substrate that has a notch in the center of each of its sides. In FIGS. 5 to 8, the components same as or equivalent to those in the above-described embodiment are designated by the same reference numerals, and description thereof is omitted to avoid redundancy. Here, it is assumed that each of these substrates 100 has strain detecting elements 201 at the same positions as those in the above-described embodiment. In FIGS. 5, 7, and 8, stresses (compressive stress and tensile stress) are represented as in the case of FIG. 3.

In the load sensor having the substrate 100 without any slit, when a load is applied to the load bearing portion 101, as shown in FIG. 5, stresses concentrate on the neighborhood of the peripheral surfaces of the load bearing portion 101 and fixed portion 103a (103c). Specifically, a compressive stress concentrate on the neighborhood of the peripheral surface of the load bearing portion 101 while a tensile stress concentrate on the neighborhood of the peripheral surface of the fixed portion 103a (103c). In particular, a high compressive stress and tensile stresses, respectively, concentrates on positions adjacent to the load bearing portion 101 and fixed portions 103, and they decrease as the position on the substrate is spaced apart from the load bearing portion 101 and fixed portions 103, respectively.

In this case, as shown in FIG. 6, the stress exhibits the maximum compressive stress in the neighborhood of the load bearing portion 101, and gradually declines up to an intermediate position between the load bearing portion 101 and the fixed portion 103. The stress changes from the compressive stress into the tensile stress with the pertinent intermediate position as a boundary, and it gradually increases from the intermediate position toward each of the fixed portions 103, until it exhibits the maximum tensile stress in the neighborhood of the fixed portion 103. For example, at the nearest position to the load bearing portion 101, a compressive stress of −3e+8 [N/m²] to −5e+8 [N/m²] is applied, and decreases in accordance with a distance from the load bearing portion 101. On the other hand, at the nearest position to the fixed portion 103, a tensile stress of +1e+8 [N/m²] to +3e+8 [N/m²] is applied, and decreases in accordance with a distance from the fixed portion 103.

As shown in FIG. 5, in a load sensor having the substrate 100 without any slit, as compared with the load sensor according to this embodiment shown in FIG. 3, the stresses (compressive stress and tensile stress) undesirably concentrate on the neighborhood of the load bearing portion 101 and fixed portions 103. This makes it difficult to detect strains of the substrate 100 by the strain detecting elements 201a, and thereby to detect the magnitude and direction of a load, with high accuracy.

On the other hand, regarding a load sensor having the substrate 100 without any round shape portion at the ends of the slits, when a load is applied to the load bearing portion 101, as shown in FIG. 7, it exhibits a stress distribution similar to that in the present load sensor shown in FIG. 3, but is subjected to a concentration of compressive stress on the neighborhood of the ends of the slits. Specifically, compressive stresses concentrate on the ends of the slits 106 adjacent to the load bearing portion 101, while tensile stresses concentrate on the ends of the slits 106 adjacent to the fixed portion 103a (103c). Also, a tensile stress concentrates on one end of each of the slits 105.

As shown in FIG. 7, in the load sensor having the substrate 100 without any round shape portion at the ends of the slits, as compared with the load sensor according to this embodiment shown in FIG. 3, stresses (compressive stress and tensile stress) concentrate on the neighborhood of the ends of the slits 106. This can cause a failure of the substrate 100 and a reduction of the product life.

Regarding the load sensor having the substrate 100 with a notch in the center of each of its sides, when a load is applied to the load bearing portion 101, as shown in FIG. 8, it exhibits a stress distribution similar to that in the present load sensor shown in FIG. 3. This indicates that the load sensor according to the present embodiment is capable of detecting the magnitude and direction of a load, with an accuracy similar to that of the substrate 100 with a notch in the center of each of its sides.

However, as shown in FIG. 8, as compared with the present load sensor shown in FIG. 3, the load sensor having the substrate 100 with a notch in the center of each of its sides has a small space for forming wiring patterns on the substrate 100. This necessitates taking countermeasures such as separately providing a space for forming wiring patterns or reducing the wiring patterns.

As described above, the load sensor according to this embodiment includes the load bearing portion 101, and strain detecting elements 201 each detecting a strain of the substrate 100 in response to a load, wherein slits 105 and 106 each of which can disperse a stress applied to the substrate in response to the load, are formed in the substrate. According to the present load sensor, a stress applied to the substrate in response to a load are dispersed by the slits 105 and 106 formed in the substrate 100, whereby it is possible to avoid stress concentration on definite positions on the substrate 100, and to detect strains of the substrate 100 in response to the appropriately dispersed stress by the strain detecting elements 201. This enables the magnitude and direction of the load to be properly detected.

In particular, in the load sensor according to this embodiment, the strain detecting elements 201 are disposed between the load bearing portion 101 and each of the fixed portions 103. Thus, by disposing the strain detecting elements 201 between and the load bearing portion 101 and each of the fixed portions 103, which are most susceptible to stress upon the substrate 100, it is possible to detect the magnitude and direction of the load with even higher accuracy.

In this embodiment, the slits 106 are formed in the neighborhood of the strain detecting elements 201. Thereby, the stress applied to the substrate 100 in the neighborhood of the strain detecting elements 201 is dispersed, so that directly detecting the dispersed stress by the strain detecting element 201 allows the magnitude and direction of the load to be detected with even higher accuracy.

In particular, in this embodiment, the pair of slits 106 is formed so as to sandwich the strain detecting elements 201. Thereby, since the stress is dispersed by the pair of slits 106 sandwiching the strain detecting elements, the stress applied to the substrate can be uniformly dispersed.

In this embodiment, the ends of the slit 106 are each formed into a round shape. Thus, by forming each of the ends of slits 106 into a round shape, the stress applied to the substrate can be borne by the round shape portions 106b of the slits 106. This makes it possible to avoid stress concentration on the ends of the slits 106, and to prevent a failure of the substrate and a reduction of the product life caused by the above-described stress concentration on the ends of the slits 106.

Especially, in this embodiment, the slits 106 are formed into a substantially heart shape. Thereby, since the stress applied to the substrate can be borne by the round shape portions included in the substantially heart shape portions, it is possible to avoid stress concentration on the ends of the slits 106, and to prevent a failure of the substrate and a reduction of the product life caused by the above-described stress concentration on the ends of the slits 106.

Also, in this embodiment, the fixed portions 103 are each disposed at the corner portion of the substantially square substrate, and the load bearing portion 101 is disposed in the central portion of this substrate 100. Thereby, since the main body of the sensor can be fixed on the mounting base at the four fixed portions, it is possible to provide a load sensor that is resistant to torsion applied to the substrate in response to a load.

The present invention is not limited to the above-described embodiment, but various changes and modifications can be made therein. In the above-described embodiment, the sizes and shapes of the parts illustrated in the accompanying drawings are not limited, but can be changed as appropriate within the scope in which the effect of the present invention is exerted. In other respects, changes can also be made as appropriate without departing the spirit and scope of the present invention.

For example, in the load sensor according to the above-described embodiment, the case was described in which the slits 105 and 106 are provided at predetermined positions on the substrate 100 in order to ensure the dispersion of stress, but the method for ensuring the dispersion of stress is not limited to this. Instead of the slits 105 and 106, opening parts corresponding to these slits may be provided. The opening parts may be formed by punching processing. At that time, as in the case of the above-described embodiment, the opening parts may be arranged pairwise so as to sandwich the strain detecting elements 201. Also, the ends of the opening parts may be each formed into round shape, and the opening parts themselves may be each formed into a heart shape. The use of such opening parts allows an effect similar to that in the above-described embodiment to be produced.

Also, in the above-described embodiment, the case was described in which the substrate 100 is formed into a square shape and its four corners are fixed on the mounting base, but the shape of the substrate 100 can be changed as appropriate. For example, the substrate 100 may be formed into a long shape and its both ends may be fixed on the mounting base. In this case also, by arranging slits 106 as in the above-described embodiment between the load bearing portion and each of fixed portions, it is possible to disperse the stress applied to the substrate in response to a load to thereby properly detect the magnitude and direction of the load.

What is claimed is:

1. A load sensor comprising:
fixed portions;
a load bearing portion subjected to a load; and
strain detecting elements each detecting a strain of a substrate in response to the load,
wherein slits each of which can disperse a stress applied to the substrate in response to the load, are formed in the substrate.

2. The load sensor according to claim 1, wherein the strain detecting elements are disposed between each of the fixed portions and the load bearing portion.

3. The load sensor according to claim 2, wherein the slits are each formed in the neighborhood of the strain detecting elements.

4. The load sensor according to claim 3, wherein a pair of the slits is formed so as to sandwich the strain detecting elements.

5. The load sensor according to claim 1, wherein the ends of the slits are each formed into a round shape.

6. The load sensor according to claim 1, wherein the slits are each formed into a substantially heart shape.

7. A load sensor comprising:
fixed portions;
a load bearing portion subjected to a load; and
strain detecting elements each detecting a strain of a substrate in response to the load,
wherein opening portions each of which can disperse a stress applied to the substrate in response to the load, are formed in the substrate.

8. The load sensor according to claim 7, wherein the strain detecting elements are disposed between each of the fixed portions and the load bearing portion.

9. The load sensor according to claim 8, wherein the opening portions are each formed in the neighborhood of the strain detecting elements.

10. The load sensor according to claim 9, wherein a pair of the opening portions is formed so as to sandwich the strain detecting elements.

11. The load sensor according to claim 7, wherein the opening portions are each formed into a substantially heart shape.

12. The load sensor according to claim 1,
wherein the fixed portions are each disposed at a corner portion of a substrate having a substantially square shape; and
wherein the load bearing portion is disposed in a central portion of the substrate.

13. The load sensor according to claim 7,
wherein the fixed portions are each disposed at a corner portion of a substrate having a substantially square shape; and
wherein the load bearing portion is disposed in a central portion of the substrate.
